(19) United States
(12) Patent Application Publication
(10) Pub. No.: US 2008/0286486 A1
(43) Pub. Date: Nov. 20, 2008

(54) Carbonate Containing Energy-Curable Compositions

(75) Inventors: Shaun L. Herlihy, Kent (GB); Brian Rowatt, Kent (GB); Robert S. Davidson, Leicester (GB)

Correspondence Address: DICKSTEIN SHAPIRO LLP, 1177 AVENUE OF THE AMERICAS (6TH AVENUE), NEW YORK, NY, 10036-2714, US

(73) Assignee: Sun Chemical Corp., Parsipanny, NJ (US)

(21) Appl. No.: 12/092,749

(22) PCT Filed: Oct. 27, 2006
(86) PCT No.: PCT/US06/41938

§ 371 Date: May 13, 2008

(30) Foreign Application Priority Data
Nov. 14, 2005 (GB) 0523200.4

(51) Int. Cl. C08F 2/48; C08F 2/46

(52) U.S. Cl. 427/521; 522/109

(57) ABSTRACT

Polyfunctional cyclic carbonates provide a useful additional monomer for energy-initiated cationic copolymerisation with such other monomers and oligomers as epoxides and oxetanes.

The present invention relates to new compositions, such as printing inks or varnishes, which are energy-curable, e.g. UV curable, via a cationic mechanism and which have excellent cure, as a result of the incorporation in the composition of a novel class of monomer, namely one or more of the polyfunctional cyclic carbonates.

Although many multifunctional cyclic carbonates are known, it has not hitherto been appreciated that they can be useful monomers in energy-curable compositions.

For example, in a review of the applications of alkylene carbonates, primarily the monofunctional ethylene carbonate and propylene carbonate, it is said “five-membered alkylene carbonates undergo ring-opening polymerisation with difficulty”, and, while the author discusses in some detail how this polymerisation may, or may not, take place, he does not suggest any uses for the resulting polymers [“Reactive applications of cyclic alkylene carbonates” by John Clements, and available as a download from the Hunts man chemical web site, http://www.huntsman.com/performanceproducts/Media//ReactiveApplicationsofCyclicAlkyleneCarbonates110903.df]

U.S. Pat. No. 6,143,857, U.S. Pat. No. 4,542,069 and various other literature references describe polyvinylene carbonate and copolymers of vinylene carbonate but these are not for energy curing applications.

U.S. Pat. No. 5,567,527 describes copolymers of vinyl ethylene carbonate with acrylic monomers, such as methyl methacrylate and butyl acrylate, to yield carbonate functional polymers which will react as crosslinkers specifically with primary amines to give urethane coatings.

U.S. Pat. No. 5,961,802 claims a coating composition containing a compound with a plurality of cyclic carbonate groups. This is for cathodic electrodepositing coating by reaction with amine groups and is not UV curing related.

U.S. Pat. No. 6,001,535 describes monomers with cyclic carbonate groups, but which include acrylate or methacrylate functional groups. Although a UV curing mechanism is used in the manufacture of printing plates using these materials, the composition cures via a free radical (acrylate) rather than a cationic mechanism as used in the present invention

Although the cationic curing of various coating compositions, including printing inks and varnishes, on exposure to ultraviolet radiation (UV) by the ring-opening polymerisation of epoxides has been known for a very long time, it has never achieved much commercial success, as a result, inter alia, of the slow cure speed of such systems. In order to make such systems commercially attractive, it is necessary to improve the cure speed of UV cationically curable epoxide-based printing inks and similar coating compositions.

We have surprisingly found that this may be achieved by the incorporation in the coating composition of at least one polyfunctional cyclic carbonate.

Propylene carbonate, a monofunctional cyclic carbonate, is commonly used as a solvent for the cationic photoinitiator in such systems (the cationic photoinitiator commonly being used as a 50% solution in propylene carbonate) and there is pressure from users of these coating compositions to reduce the level of propylene carbonate, on the basis that it may migrate out of the cured composition. Moreover, propylene carbonate is deemed by most formulators and end users to be an unreactive component, and so it would not be expected to have a positive effect on cure. Indeed, U.S. Pat. No. 5,262,449 states specifically that simple alkylene carbonates are merely solvents and play no part in polymerisation, and that they should be used in relatively low amounts to avoid undesired effects.

Moreover, ink formulators are always trying to improve and extend the uses of their inks. The discovery of a new class of polymerisable monomer for use in cationic energy curing allows a much wider range of variation in properties of the finished ink to be achieved.

Thus, the present invention consists in an energy-curable composition comprising a polyfunctional cyclic carbonate, a monomer or oligomer copolymerisable with said polyfunctional cyclic carbonate and a cationic photoinitiator.

The term “polyfunctional cyclic carbonate” as used herein means a compound having two or more cyclic carbonate groups which are capable of participation in a ring-opening polymerisation process.

A preferred class of polyfunctional cyclic carbonate compounds for use in the present invention comprises those compounds of formula (I):

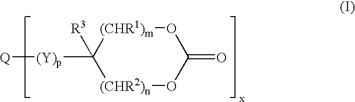

in which:
Q represents a polyvalent organic residue having a valency x>1 or a direct bond;
Y is an aliphatic carbon chain which may be interrupted by one or more oxygen atoms, sulphur atoms, phenylene groups, carbonyl groups, epoxide groups or linear or cyclic carbonate groups;
p is 0 or 1;
R¹ and R² are the same as or different from each other, and each represents a hydrogen atom, an alkyl group, a hydroxyalkyl group, an alkoxyalkyl group, an alkoxycarbonylalkyl group or a C₂-C₅ carbon chain which is attached to a carbon atom of Y to form a fused ring;
R³ represents a hydrogen atom or an alkyl group; and
m and n are the same as or different from each other, and each is zero or a number from 1 to 4, provided that (m+n) is zero or a number from 1 to 4.

In these compounds of formula (I), Q is a polyvalent organic residue having a valency x, which is preferably from 2 to 4. Examples of groups which may be represented by Q include bisphenol A and bisphenol F residues, groups of formula —O—CO—CH₂—, polymethylene groups (e.g. trimethylene, tetramethylene, pentamethylene, hexamethylene, heptamethylene, octamethylene and nonamethylene groups), cycloalkylene groups (e.g. cyclopentylene or cyclohexylene groups), bis(alkylene)oxy (e.g. —CH₂—O—CH₂— or —C₂H₅—O—C₂H₅—), divalent and trivalent groups derived from benzene, and groups derived from polyols and esters thereof,

Where Y is present, it is an aliphatic carbon chain which may be interrupted by one or more oxygen atoms, sulphur atoms, phenylene groups, carbonyl groups, epoxide groups or linear or cyclic carbonate groups. It preferably has from 1 to 20 atoms in its aliphatic chain.

Of these compounds, we prefer those compounds having the formula (Ia):

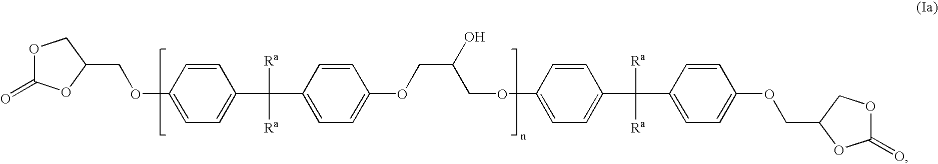

in which R^{a} represents a hydrogen atom or a methyl group and n is a degree of polymerisation.

A further preferred class of compounds for use in the present invention comprises those compounds of formula (II):

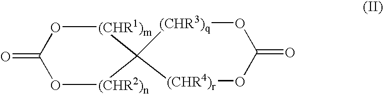

in which:
R¹, R², R³ and R⁴ are the same as or different from each other, and each represents a hydrogen atom, an alkyl group, a hydroxyalkyl group, an alkoxyalkyl group, or an alkoxycarbonylalkyl group;
m and n are the same as or different from each other, and each is zero or a number from 1 to 4, provided that (m+n) is zero or a number from 1 to 4; and
q and r are the same as or different from each other, and each is zero or a number from 1 to 4, provided that (q+r) is zero or a number from 1 to 4.

In the compounds of formulae (I) and (II), where R¹, R², R³ or R⁴ represents an alkyl group, this may be a straight or branched chain group having from 1 to 20, more preferably from 1 to 10, still more preferably from 1 to 6 and most preferably from 1 to 3, carbon atoms, and examples of such groups include the methyl, ethyl, propyl, isopropyl, butyl, isobutyl, t-butyl, pentyl, isopentyl, neopentyl, 2-methylbutyl, 1-ethylpropyl, 4-methylpentyl, 3-methylpentyl, 2-methylpentyl, 1-methylpentyl, 3,3-dimethylbutyl, 2,2-dimethylbutyl, 1,1-dimethylbutyl, 1,2-dimethylbutyl, 1,3-dimethylbutyl, 2,3-dimethylbutyl, 2-ethylbutyl, hexyl, isohexyl, heptyl, octyl, nonyl, decyl, dodecyl, tridecyl, pentadecyl, octadecyl, nonadecyl and icosyl groups, but preferably the methyl, ethyl, propyl and t-butyl groups, and most preferably the methyl or ethyl group.

Where R¹, R², R³ or R⁴ represents a hydroxyalkyl group, this may be a straight or branched chain group having from 1 to 6, preferably from 1 to 4, carbon atoms, and examples include the hydroxymethyl, 1- or 2-hydroxyethyl, 1-, 2- or 3-hydroxypropyl, 1- or 2-hydroxy-2-methylethyl, 1-, 2-, 3- or 4-hydroxybutyl, 1-, 2-, 3-, 4- or 5-hydroxypentyl or 1-, 2-, 3-, 4-, 5- or 6-hydroxyhexyl groups. Of these, we prefer those hydroxyalkyl groups having from 1 to 4 carbon atoms, preferably the hydroxymethyl, 2-hydroxyethyl, 3-hydroxypropyl and 4-hydroxybutyl groups, and most preferably the hydroxymethyl group.

Where R¹, R², R³ or R⁴ represents an alkoxyalkyl group, the alkoxy and alkyl parts both preferably have from 1 to 6 carbon atoms, and examples include the methoxymethyl, ethoxymethyl, propoxymethyl, isopropoxymethyl, butoxymethyl, 2-methoxyethyl, 3-methoxypropyl, 2-methoxypropyl and 4-ethoxybutyl groups.

Where R¹, R², R³ or R⁴ represents an alkoxycarbonylalkyl group, the alkoxy and alkyl parts both preferably have from 1 to 6 carbon atoms, and examples include the methoxycarbonylmethyl, ethoxycarbonylmethyl, propoxycarbonylmethyl, isopropoxycarbonylmethyl, butoxycarbonylmethyl, 2-methoxycarbonylethyl, 3-methoxycarbonylpropyl, 2-methoxycarbonylpropyl and 4-ethoxycarbonylbutyl groups.

In formula (I), where R¹ or R² represents a carbon chain forming, with a carbon atom of Y a fused ring, this has from 2 to 5 carbon atoms and may be, for example, a dimethylene, trimethylene, tetramethylene or pentamethylene group.

An example of the compounds of formula (II) is the compound of formula (III):

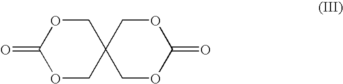

Alternatively, the polyfunctional cyclic carbonate may be a polymeric compound having pendant carbonate groups, for example the compounds of formula (IV):

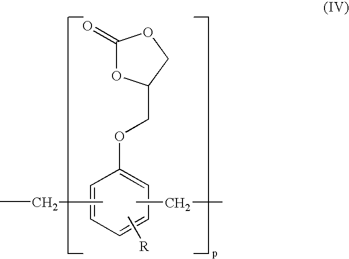

in which p is a number denoting a degree of polymerisation and R represents a hydrogen atom or an alkyl group, e.g. a methyl or ethyl group.

As a further alternative, the polyfunctional cyclic carbonate may be a polymeric compound having carbonate groups in the main polymer chain, for example a polyvinylene carbonate.

Examples of preferred polyfunctional cyclic carbonates for use in the present invention include compounds of formulae:

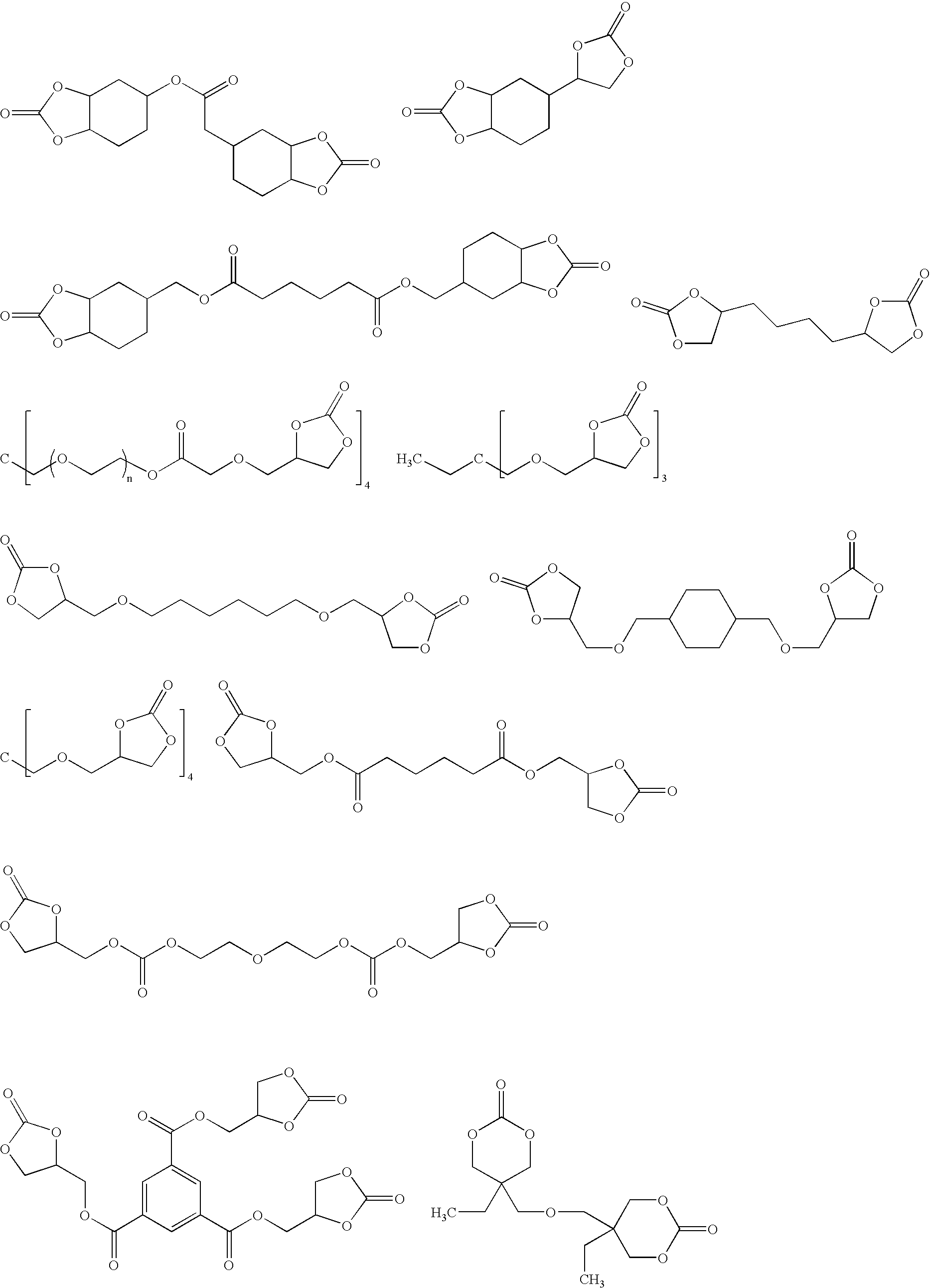

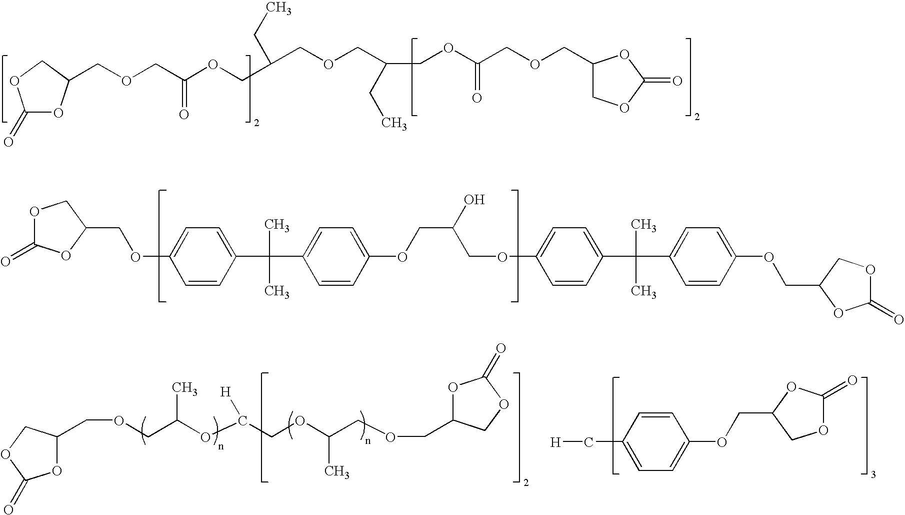

where n is a number denoting a degree of polymerisation, as well as epoxidised soya bean oil carbonate or epoxidised linseed oil carbonate.

We prefer that the polyfunctional cyclic carbonate should comprise from 1 to 50% by weight, more preferably from 10 to 30% by weight, and most preferably from 15 to 25% by weight, of the total polymerisable components of the composition.

5-Membered cyclic carbonates are easily prepared on an industrial scale, for example by carbon dioxide insertion into epoxide groups or other known methods.

Preferred copolymerisable monomers or oligomers for use in the compositions of the present invention include epoxides, oxetanes, and sulphur analogues thereof, in particular epoxides and/or oxetanes, of which the cycloaliphatic epoxides are preferred.

Typical epoxides which may be used include the cycloaliphatic epoxides (such as those sold under the designations Cyracure UVR6105, UVR6107, UVR6110 and UVR6128, by Dow), which are well known to those skilled in the art.

Other epoxides which may be used include such epoxy-functional oligomers/monomers as the glycidyl ethers of polyols [bisphenol A, alkyl diols or poly(alkylene oxides), which be di-, tri-, tetra- or hexa-functional]. Also, epoxides derived by the epoxidation of unsaturated materials may also be used (e.g. epoxidised soybean oil, epoxidised polybutadiene or epoxidised alkenes). Naturally occurring epoxides may also be used, including the crop oil collected from Vernonia galamensis.

Examples of suitable oxetanes include 3-ethyl-3-hydroxymethyl-oxetane, 3-ethyl-3-[2-ethylhexyloxy)methyl]oxetane, bis[1-ethyl(3-oxetanyl)]methyl ether, bis[1-ethyl(3-oxetanyl)]methyl ether, oxetane functional novolac polymers and methyl silicon trioxetane.

As well as epoxides and optionally oxetanes, other reactive monomers/oligomers which may be used include the vinyl ethers of polyols [such as triethylene glycol divinyl ether, 1,4-cyclohexane dimethanol divinyl ether and the vinyl ethers of poly(alkylene oxides)]. Examples of vinyl ether functional prepolymers include the urethane-based products supplied by Allied Signal. Similarly, monomers/oligomers containing propenyl ether groups may be used in place of the corresponding compounds referred to above containing vinyl ether groups.

Other reactive species can include styrene derivatives and cyclic esters (such as lactones and their derivatives).

The composition of the present invention also contains a cationic photoinitiator. There is no particular restriction on the particular cationic photoinitiator used, and any cationic photoinitiator known in the art may be employed. Examples of such cationic photoinitiators include sulphonium salts (such as the mixture of compounds available under the trade name UVI6992 from Dow Chemical), thianthrenium salts (such as Esacure 1187 available from Lamberti), iodonium salts (such as IGM 440 from IGM) and phenacyl sulphonium salts. However, particularly preferred cationic photoinitiators are the thioxanthonium salts, such as those described in WO 03/072567 A1, WO 03/072568 A1, and WO 2004/055000 A1, the disclosures of which are incorporated herein by reference.

Particularly preferred thioxanthonium salts are those of formulae (I), (II) and (III):

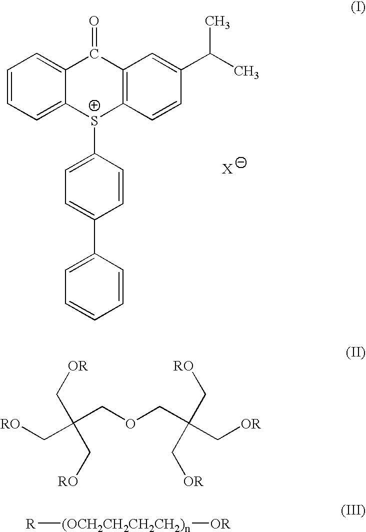

in which each R represents a group of formula (IV):

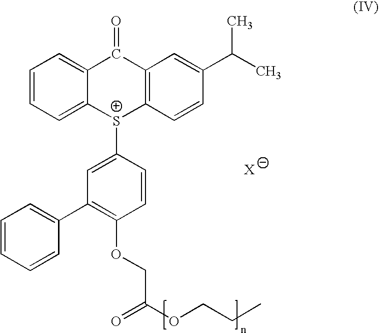

where n is a number and X⁻ is an anion, especially the hexafluorophosphates. The hexafluorophosphates of the compounds of formulae (I) and (II) are available from IGM under the trade marks IGM 550 and IGM 650 respectively.

The composition of the present invention may be formulated as a printing ink, varnish, adhesive, paint or any other coating composition which is intended to be cured by energy, which may be supplied by irradiation, whether by ultraviolet or electron beam. Such compositions will normally contain at least a polymerisable monomer, prepolymer or oligomer, and a cationic photoinitiator, as well as the cyclic carbonate, but may also include other components well known to those skilled in the art, for example, reactive diluents and, in the case of printing inks and paints, a pigment or dye.

It is also common to include polyols in ultraviolet cationic curable formulations, which promote the cross-linking by a chain-transfer process. Examples of polyols include the ethoxylated/propoxylated derivatives of, for example, trimethylolpropane, pentaerythritol, di-trimethylolpropane, di-pentaerythritol and sorbitan esters, as well as more conventional poly(ethylene oxide)s and poly(propylene oxide)s. Other polyols well known to those skilled in the art are the polycaprolactone diols, triols and tetraols, such as those supplied by Dow.

Additives which may be used in conjunction with the principal components of the coating formulations of the present invention include stabilisers, plasticisers, pigments, waxes, slip aids, levelling aids, adhesion promoters, surfactants and fillers.

The amounts of the various components of the curable composition of the present invention may vary over a wide range and, in general, are not critical to the present invention. However, we prefer that the amount of the polymerisable components (i.e. the epoxide, oxetane, if used, and other monomers, prepolymers and oligomers, if used) should be from 40 to 90% of the total composition. The epoxide(s) preferably comprise from 30 to 80% of the polymerisable components in the composition of the present invention, and the oxetanes, preferably multi-functional oxetane(s), if used, preferably comprise from 5 to 40% of the polymerisable components in the composition of the present invention. The amount of cationic photoinitiator is normally from 1.0 to 10% by weight, more preferably from 2.0 to 8%, by weight of the entire composition.

Other components of the curable composition may be included in amounts well known to those skilled in the art.

The curable compositions of this invention may be suitable for applications that include protective, decorative and insulating coatings; potting compounds; sealants; adhesives; photoresists; textile coatings; and laminates. The compositions may be applied to a variety of substrates, e.g., metal, rubber, plastic, wood, moulded parts, films, paper, glass cloth, concrete, and ceramic. The curable compositions of this invention are particularly useful as inks for use in a variety of printing processes, including, but not limited to, lithography, flexography, inkjet and gravure. Details of such printing processes and of the properties of inks needed for them are well known and may be found, for example, in The Printing Ink Manual, 5^{th} Edition, edited by R. H. Leach et al., published in 1993 by Blueprint, the disclosure of which is incorporated herein by reference.

In particular, unlike many other ink formulations, it is possible to vary the viscosity of coating compositions of the present invention over a very wide range, from the relatively low viscosities required for flexographic and inkjet processes to the rather higher viscosities required for lithographic inks and varnishes.

Where the compositions of the present invention are used for inks, these typically comprise, as additional components to those referred to above, one or more of pigments, waxes, stabilisers, and flow aids, for example as described in “The Printing Ink Manual”.

Thus, the invention also provides a process for preparing a cured coating composition, which comprises applying a composition according to the present invention to a substrate and exposing the coated substrate to curing radiation sufficient to cure the coating.

The invention is further illustrated by the following non-limiting Examples. It should be noted that the compounds prepared as Examples No. 5, 7, 11, and 21, which are all monofunctional cyclic carbonates, are not compounds for use in the invention and are included merely for comparative purposes in the evaluation Examples.

### EXAMPLE 1

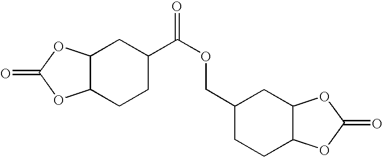

50.0 g of 3,4-Epoxycyclohexylmethyl 3,4-epoxycyclohexane-carboxylate (0.198 moles) and 1.0 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 63.77 g (94.56%) of a clear yellow liquid.

The product was analysed by IR.

IR: very strong carbonate peak at 1800 cm⁻¹.

### EXAMPLE 2

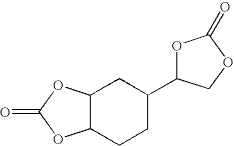

10.0 g of vinyl cyclohexene dioxide (0.0714 moles) and 0.1 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 14.83 g (91.06%) of a clear yellow liquid.

The product was analysed by IR.

IR: very strong carbonate peak at 1790 cm⁻¹.

### EXAMPLE 3

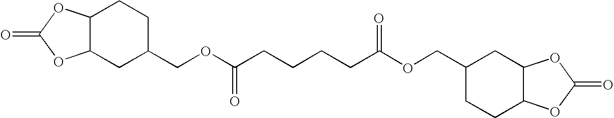

20.0 g of bis(3,4-epoxycyclohexylmethyl)adipate (0.0546 moles) and 0.2 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 22.28 g (89.83%) of a clear yellow liquid.

The product was analysed by IR.

IR: very strong carbonate peak at 1801 cm⁻¹.

### EXAMPLE 4

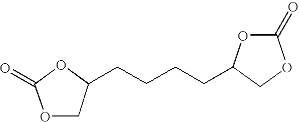

50.0 g of octanetetrol (0.2809 moles), 130.0 g ethyl chloroformate (1.197 moles) and 550 ml of tetrahydrofuran were mixed in a 1 litre three necked round bottomed flask equipped with a stirrer, temperature probe and a dropping funnel. The mixture was cooled to <10° C. using an ice/water bath. 120.0 g of triethylamine (1.188 moles) in 200 ml of tetrahydrofuran were added dropwise ensuring the temperature did not rise above 20° C. The mixture was then allowed to rise to room temperature. The precipitate that had formed was removed by filtration. The solvent was then removed by rotary evaporator to yield the product.

Product yield 50.08 g (77.51%).
The product was analysed by IR.
IR: very strong carbonate peak at 1794 cm⁻¹.

### EXAMPLE 5

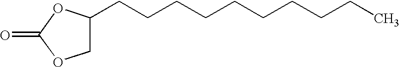

11.11 g of dodecanediol (0.04942 moles), 10.73 g ethyl chloroformate (0.09885 moles) and 60 ml of tetrahydrofuran were mixed in a 500 ml three necked round bottomed flask equipped with a stirrer, temperature probe and a dropping funnel. The mixture was cooled to 0° C. using an ice/water bath. 9.984 g of triethylamine (0.09885 moles) in 20 ml of tetrahydrofuran were added dropwise ensuring the temperature did not rise above 15° C. The mixture was then allowed to rise to room temperature. The precipitate that had formed was removed by filtration. The solvent was then removed by rotary evaporator to yield the product.

Product yield 11.16 g (90.04%).
The product was analysed by IR.
IR: very strong carbonate peak at 1801 cm⁻¹.

### EXAMPLE 6

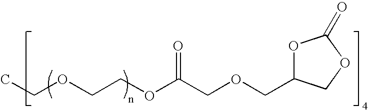

Ethoxylated pentaerythritol ¾ (10.125 g, 0.0375 moles), bromoacetic acid (22.9 g, 0.165 moles), 0.375 g p-toluenesulphonic acid, 0.075 g butylated hydroxytoluene and 50 ml toluene were azeotropically refluxed for 5 hours. The solution was washed with 2×100 ml 10% aqueous potassium carbonate solution and 3×100 ml deionised water. The organics were dried using anhydrous magnesium sulphate and then the solvent was removed on a rotary evaporator to yield the intermediate product—[tetra(bromoacetic ester) of ethoxylated pentaerythritol ¾].

Yield=21.14 g colourless low viscosity liquid.
The product was analysed by IR.
IR: very strong ester peak at 1738 cm⁻¹.

5.0 g of the intermediate product (0.006635 moles), 3.23 g of glycerine carbonate (0.0274 moles), 0.2 g of tetrabutyl ammonium bromide, 10.0 g of potassium carbonate powder and 25 ml of acetone were mixed in a flask equipped with a condenser, mechanical stirrer and a temperature probe. The mixture was heated to reflux for a total of 6 hours. Additional acetone was added to top-up the solvent volume as some solvent was lost by evaporation through the mechanical stirrer joint. The mixture was then cooled and filtered to remove the inorganics. 250 ml of ethyl acetate was added to the organic phase which was then washed with 2×100 ml of water. The organic phase was then dried with anhydrous magnesium sulphate and the solvent removed on a rotary evaporator to yield the product.

Yield=3.48 g (58.15%) of a viscous liquid.
The product was analysed by IR.
IR: very strong carbonate peak at 1792 cm⁻¹, very strong ester peak at 1751 cm⁻¹.

### EXAMPLE 7

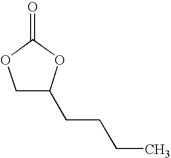

10.0 g of epoxy hexane (0.1 moles) and 0.2 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 12.80 g (88.89%) of a clear yellow liquid.

The product was analysed by IR.

IR: very strong carbonate peak at 1799 cm⁻¹.

### EXAMPLE 8

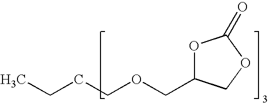

20.0 g of trimethylol propane triglycidyl ether (0.0662 moles) and 0.2 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 26.70 g (92.90%) of a clear yellow liquid.

The product was analysed by IR.

IR: very strong carbonate peak at 1792 cm⁻¹.

### EXAMPLE 9

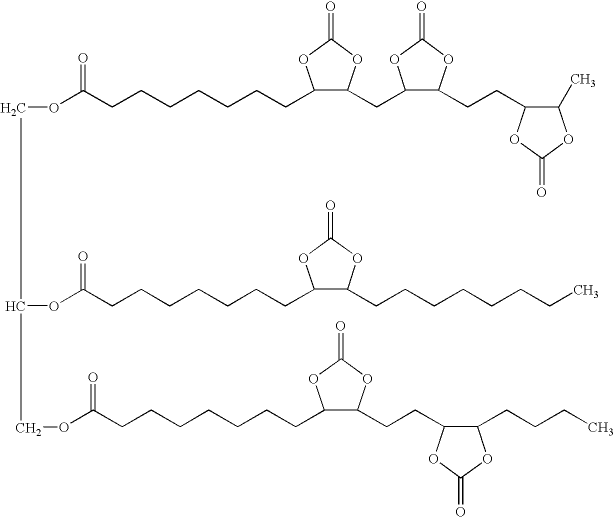

20.0 g of Vikoflex 7170 epoxidised soya bean oil and 0.4 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 18.65 g of a clear yellow liquid.

The product was analysed by IR.

IR: very strong carbonate peak at 1806 cm⁻¹.

### EXAMPLE 10

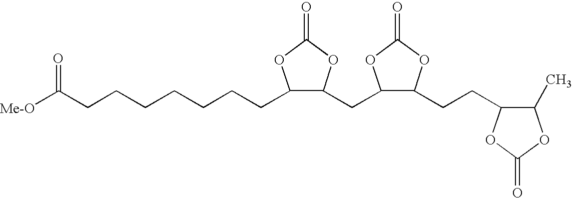

30.0 g of Vikoflex 9010 epoxidised linseed oil and 0.6 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 31.0 g of a yellow liquid.

The product was analysed by IR.

IR: very strong carbonate peak at 1804 cm¹.

### EXAMPLE 11

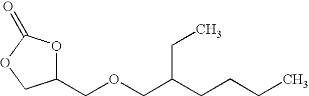

50.0 g of ethylhexyl glycidyl ether (0.269 moles) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 61.6 g (99.63%) of a yellow liquid.

The product was analysed by IR.

IR: very strong carbonate peak at 1797 cm⁻¹.

### EXAMPLE 12

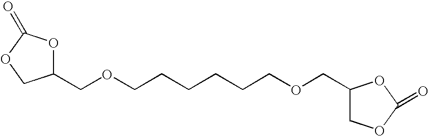

50.0 g of hexanediol diglycidyl ether (0.217 moles) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 61.0 g (88.24%) of a yellow liquid.

The product was analysed by IR.

IR: very strong carbonate peak at 1794 cm⁻¹.

### EXAMPLE 13

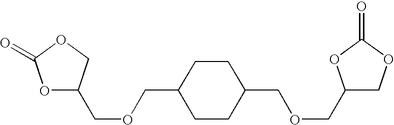

50.0 g of 1,4-cyclohexanedimethanol diglycidyl ether (0.197 moles) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 60.0 g (89.12%) of a yellow liquid.

The product was analysed by IR.

IR: very strong carbonate peak at 1794 cm⁻¹.

### EXAMPLE 14

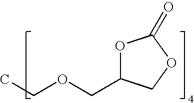

50.0 g of pentaerythritol tetraglycidyl ether (Polypox R16) (0.139 moles) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 58.9 g (79.12%) of a yellow viscous liquid.

The product was analysed by IR.

IR: very strong carbonate peak at 1789 cm⁻¹.

### EXAMPLE 15

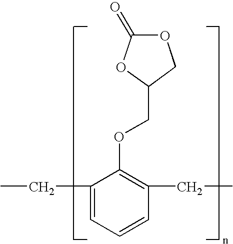

50.0 g of Epoxy Novolac DEN 431 and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 61.5 g of a yellow solid.

The product was analysed by IR.

IR: very strong carbonate peak at 1794 cm⁻¹.

### EXAMPLE 16

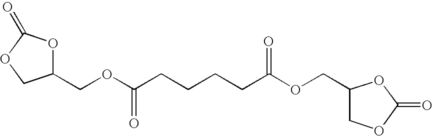

23.6 g of glycerine carbonate (0.2 moles), 20.2 g of triethylamine (0.2 moles) and 300 ml of dichloromethane were mixed in a 1 litre reaction vessel. The mixture was cooled to 5° C. 18.3 g of adipoyl chloride (0.1 moles) in 50 ml of dichloromethane were then added slowly over approximately 30 minutes keeping the temperature in the range 5-10° C. The mixture was then stirred for 5-10 minutes and then 200 ml of water was added and the solution separated. The dichloromethane layer was washed with 250 ml of 10% sodium carbonate solution and then 2×200 ml of water. The dichloromethane layer was dried with anhydrous magnesium sulphate and the solvent then removed to yield the product.
Product yield 29.998 g (86.7%) of a dark brown oil.
The product was analysed by IR.
IR: very strong carbonate peak at 1796 cm⁻¹, strong ester peak at 1739 cm⁻¹.

### EXAMPLE 17

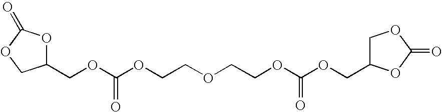

23.6 g of glycerine carbonate (0.2 mmoles), 20.2 g of triethylamine (0.2 mmoles) and 250 ml of dichloromethane were mixed in a 1 litre reaction vessel. The mixture was cooled to 5° C. 23.1 g of diethyleneglycol bischloroformate (0.1 moles) in 50 ml of dichloromethane were then added slowly over approximately 30 minutes keeping the temperature in the range 5-10° C. The mixture was then stirred for 2 minutes and then 200 ml of water was added and the solution separated. The dichloromethane layer was washed with 200 ml of 10% sodium carbonate solution and then 2×200 ml of water. The dichloromethane layer was dried with anhydrous magnesium sulphate and the solvent then removed to yield the product.

Product yield 18.16 g (46.1%) of a straw coloured viscous liquid.
The product was analysed by IR.
IR: very strong carbonate peak at 1800 cm⁻¹, strong ester peak at 1757 cm⁻¹.

### EXAMPLE 18

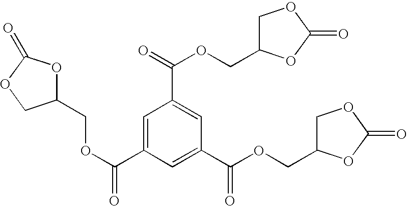

23.6 g of glycerine carbonate (0.2 moles), 20.2 g of triethylamine (0.2 moles) and 200 ml of dichloromethane were mixed in a 1 litre reaction vessel. The mixture was cooled to 5° C. 17.71 g of benzene tricarbonyl trichloride (0.0667 moles) in 100 ml of dichloromethane were then added slowly over approximately 1 hour keeping the temperature in the range 5-10° C. 200 ml of water was then added and the solution separated. The dichloromethane layer was washed with 200 ml of 10% sodium carbonate solution and then 200 ml of water. The dichloromethane layer was dried with anhydrous magnesium sulphate and the solvent then removed to yield the product.

Product yield 10.5 g (28.85%) of white crystals.
The product was analysed by IR.
IR: very strong carbonate peak at 1794 cm⁻¹, strong ester peak at 1735 cm⁻¹.

### EXAMPLE 19

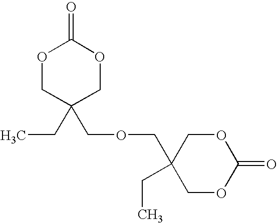

10.0 g of di(trimethylolpropane) (0.04 moles), 17.36 g ethyl chloroformate (0.16 moles) and 150 ml of tetrahydrofuran were mixed in a 500 ml three necked round bottomed flask equipped with a stirrer, temperature probe and a dropping funnel. The mixture was cooled to 0° C. using an ice/water bath. 16.16 g of triethylamine (0.16 moles) in 40 ml of tetrahydrofuran were added dropwise ensuring the temperature did not rise above 10° C. The mixture was then allowed to rise to room temperature. The precipitate that had formed was removed by filtration. The solvent was then removed by rotary evaporator to yield the crude product. The product was crystallised by adding anhydrous ether. The product was collected by vacuum filtration.

Product yield 10.01 g (82.86%).
The product was analysed by IR.
IR: very strong carbonate peak at 1743 cm⁻¹.

### EXAMPLE 20

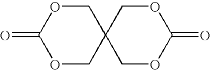

10.0 g of pentaerythritol (0.0735 moles), 31.91 g ethyl chloroformate (0.294 moles) and 150 ml of tetrahydrofuran were mixed in a 500 ml three necked round bottomed flask equipped with a stirrer, temperature probe and a dropping funnel. The mixture was cooled to 0° C. using an ice/water bath. 29.71 g of triethylamine (0.294 moles) in 40 ml of tetrahydrofuran were added dropwise ensuring the temperature did not rise above 10° C. An additional 50 ml of tetrahydrofuran was added about half way through the triethylamine addition to reduce the viscosity of the mixture so that efficient stirring was obtained. The mixture was then allowed to rise to room temperature. The precipitate that had formed was removed by filtration. The solvent was then removed by rotary evaporator. The crude product was redissolved in 50 ml of methyl ethyl ketone/diethyl ether 1:1 and washed with 2×25 ml of water. The organics were then dried with anhydrous magnesium sulphate and then the solvent was removed by rotary evaporator to yield the product.

Product yield 5.19 g (37.56%).
The product was analysed by IR.
IR: very strong carbonate peak at 1820 and 1755 cm⁻¹.

### EXAMPLE 21

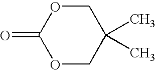

13.52 g of neopentyl glycol (0.13 moles), 28.40 g ethyl chloroformate (0.26 moles) and 260 ml of tetrahydrofuran were mixed in a 500 ml three necked round bottomed flask equipped with a stirrer, temperature probe and a dropping funnel. The mixture was cooled to 0° C. using an ice/water bath. 26.5 g of triethylamine (0.26 moles) in 65 ml of tetrahydrofuran were added dropwise ensuring the temperature did not rise above 10° C. The mixture was then allowed to rise to room temperature. The precipitate that had formed was removed by filtration. The solvent was then removed by rotary evaporator to yield the crude product. The crude product was recrystallised from ether.

Product yield 9.68 g (57.3%) of white crystals.
The product was analysed by IR.
IR: very strong carbonate peak centred at 1743 cm⁻¹.

### EXAMPLE 22

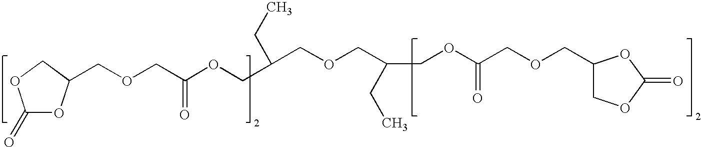

Di(trimethylolpropane) (10.00 g, 0.03995 moles), bromoacetic acid (24.41 g, 0.1757 moles), 0.375 g p-toluenesulphonic acid, 0.075 g butylated hydroxytoluene and 60 ml toluene were azeotropically refluxed for 10 hours. The solution was washed with 2×100 ml 10% aqueous potassium carbonate solution and 3×100 ml deionised water The organics were dried using anhydrous magnesium sulphate and then the solvent was removed on a rotary evaporator to yield the intermediate product-tetra(bromoacetic ester) of di(trimethylolpropane).

Yield=21.14 g colourless liquid.
The product was analysed by IR.
IR: very strong ester peak at 1738 cm⁻¹.

20.0 g of the intermediate product (0.02725 moles), 13.27 g of glycerine carbonate (0.1125 moles), 0.82 g of tetrabutylammonium bromide, 40.0 g of potassium carbonate powder and 100 ml of acetone were mixed in a flask equipped with a condenser, mechanical stirrer and a temperature probe. The mixture was heated to reflux for a total of 6 hours. Additional acetone was added to top-up the solvent volume as some solvent was lost by evaporation through the mechanical stirrer joint. The mixture was then cooled and filtered to remove the inorganics. 200 ml of ethyl acetate was added to the organic phase which was then washed with 2×100 ml of water. The organic phase was then dried with anhydrous magnesium sulphate and the solvent removed on a rotary evaporator to yield the product.

Yield=20.45 g (85.1%) of a viscous liquid.
The product was analysed by IR.
IR: very strong carbonate peak at 1791 cm⁻¹, very strong ester peak at 1751 cm⁻¹.

### EXAMPLE 23

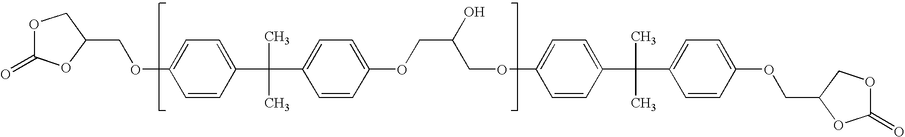

50.0 g of DER 330 Epoxy resin of Bisphenol A (180 epoxy equivalent weight) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 56.0 g of a yellow solid.

The product was analysed by IR.

IR: very strong carbonate peak at 1791 cm⁻¹.

### EXAMPLE 24

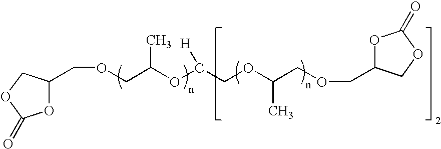

40.0 g of Glycerol propoxylate triglycidyl ether (average molecular weight 1950) and 0.4 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 41.0 g of a yellow solid.

The product was analysed by IR.

IR: very strong carbonate peak at 1800 cm⁻¹.

### EXAMPLE 25

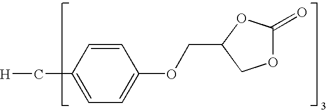

40.0 g of triphenylolmethane triglycidyl ether and 0.4 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure the reactor was cooled and the pressure released. The product was isolated by dissolving in dichloromethane, washing with 2×100 ml of water, drying the organic phase with anhydrous magnesium sulphate and removing the solvent on a rotary evaporator.

Product yield 44.2 g of a yellow solid.

The product was analysed by IR.

IR: very strong carbonate peak at 1794 cm⁻¹.

### EXAMPLE 26

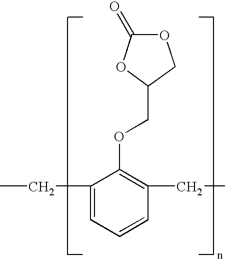

50.0 g of DEN 438 Epoxy Novolac and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 49.4 g of a yellow solid.

The product was analysed by IR.

IR: very strong carbonate peak at 1797 cm⁻¹.

### EXAMPLE 27

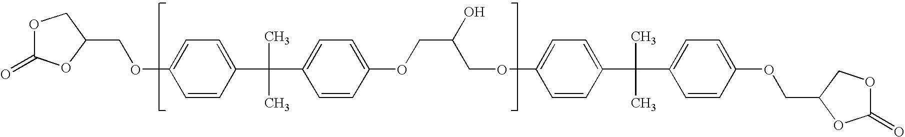

50.0 g of DER 661 Epoxy resin (500 epoxy equivalent weight) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 50.2 g of a yellow solid.

The product was analysed by IR.

IR: carbonate peak at 1798 cm⁻¹.

### EXAMPLE 28

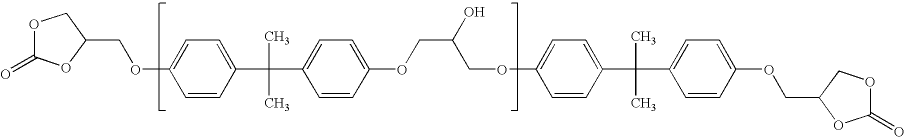

50.0 g of DER 664 U Epoxy resin (900 epoxy equivalent weight) and 0.5 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 50.0 g of a yellow solid.

The product was analysed by IR.

IR: carbonate peak at 1799 cm⁻¹.

### EXAMPLE 29

Varnish formulations were prepared based on

| | |
|---|---|
| S-biphenyl thianthrenium hexafluorophosphate | 2% |
| Tegorad 2100 wetting aid ex TEGO | 0.1% |
| Carbonates shown in Table 1 | 0-50% |
| UVR6105 cycloaliphatic epoxide ex DOW | Remainder |

All formulations were printed onto Lenetta charts using a No. 1 K bar and cured under a 300 W/inch medium pressure mercury arc lamp. The maximum line speed for tack free cure was evaluated at a carbonate content of 0-50% for carbonate functionalities of 1, 2, 3 & 4, and is shown in Table 1.

TABLE 1

| | Max tack free cure speed m/minute | | | | |
|---|---|---|---|---|---|
| percent | Monofunctional | Difunctional | Difunctional | Trifunctional | Tetrafunctional |
| carbonate | Example 11 | Example 13 | Example 12 | Example 8 | Example 14 |
| 0 | 55 | 55 | 55 | 55 | 55 |
| 10 | 50 | 60 | 55 | 65 | 60 |
| 20 | 45 | 65 | 50 | 65 | 70 |
| 30 | 35 | 55 | 40 | 60 | 60 |
| 40 | 30 | 45 | 25 | 45 | 60 |
| 50 | 20 | 40 | 15 | 40 | * |

These results demonstrate that compounds with cyclic carbonate functionalities of 2 or more tend to increase the tack free cure speed over monofunctional carbonates at equivalent levels and carbonate free formulations. Concentrations of around 20% appear to give highest reactivity.

### EXAMPLE 30

Varnish formulations were prepared based on

| | |
|---|---|
| S-biphenyl thianthrenium hexafluorophosphate | 2% |
| Tegorad 2100 wetting aid ex TEGO | 0.1% |
| Carbonates shown in Table 2 | 0-50% |
| UVR6105 cycloaliphatic epoxide ex DOW | Remainder |

All formulations were printed onto Lenetta charts using a No. 1 K bar and cured under a 300 W/inch medium pressure mercury arc lamp at 50 m/minute and then left to post-cure for 1 hour. The isopropanol (IPA) solvent resistance of the cured films was assessed using the SATRA STM 421 rub tester at carbonate contents of 0-50% for carbonate functionalities of 1, 2, 3 & 4, and the results are shown in Table 2.

TABLE 2

| | IPA rubs | | | | |
|---|---|---|---|---|---|
| | Mono- | Di- | Di- | Tri- | |
| | functional | functional | functional | functional | Tetra- |
| percent | Example | Example | Example | Example | functional |
| carbonate | 11 | 13 | 12 | 8 | Example 14 |
| 0 | 12 | 12 | 12 | 12 | 12 |
| 10 | 34 | 38 | 54 | 55 | 53 |
| 20 | 52 | 45 | 78 | 51 | 53 |
| 30 | 17 | 23 | 38 | 38 | 54 |
| 40 | 9 | 19 | 19 | 36 | 34 |
| 50 | 12 | 14 | 14 | 17 | 26 |

These results demonstrate that compounds with cyclic carbonate groups increase the IPA resistance of cured films, and in particular compounds with higher carbonate functionalities, particularly tri and tetra functional, maintain high solvent resistance at higher incorporation levels relative to monofunctional materials.

### EXAMPLE 31

Varnish formulations were prepared based on

| | |
|---|---|
| S-biphenyl thianthrenium hexafluorophosphate | 3.5% |
| Tegorad 2100 wetting aid ex TEGO | 0.1% |
| Carbonate Examples 1, 2, 3, 4, 5, 6, 7 | 15% |
| UVR6105 cycloaliphatic epoxide ex DOW | 81.4% |

All formulations were printed onto Lenetta charts using a No. 1 K bar and cured under a 300 W/inch medium pressure mercury arc lamp. All samples cured to a tack free state at a speed of at least 100 m/minute, compared to a tack free cure speed of 110 m/minute for a formulation where no cyclic carbonate compound was present.

These results demonstrate that compounds with cyclic carbonate functionalities of varying structures can be incorporated into formulations without adversely affecting their cure speed.

### EXAMPLE 32

Varnish formulations were prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| Carbonate Examples 9 & 10 | 0-25% |
| UVR6105 cycloaliphatic epoxide ex DOW | Remainder |

All formulations were printed onto Lenetta charts using a No. 1 K bar and cured under a 300 W/inch medium pressure mercury arc lamp. The maximum line speed for tack free cure was evaluated at a carbonate content of 0-25% for carbonate Examples 9 & 10. The results are shown in Table 3.

TABLE 3

| | |
|---|---|
| | Max tack free cure |
| Percent | speed m/min |

| carbonate | Example 9 | Example 10 |
|---|---|---|
| 2 | >100 | >100 |
| 5 | >100 | >100 |
| 10 | >100 | >100 |
| 15 | >100 | >100 |
| 20 | 90 | >100 |
| 25 | 40 | 80 |

These results demonstrate that cyclic carbonate compounds derived from highly flexibilising fatty acid epoxide compounds can be incorporated into formulations at up to 15-20% without significantly affecting their cure speed.

### EXAMPLE 33

Varnish formulations were prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| Carbonate Example 4 | 0-20% |
| UVR6105 cycloaliphatic epoxide ex DOW | Remainder |

All formulations were printed onto Lenetta charts using a No. 1 K bar and cured at 100 nm/minute under a 300 W/inch medium pressure mercury arc lamp operating at half power. Cure was assessed using the well known MEK solvent rub method immediately after cure, 5 minutes, 15 minutes, 1 hour and 3 hours after cure. The results are shown in Table 4.

TABLE 4

| percent | MEK double rubs | | | | |
|---|---|---|---|---|---|
| carbonate | Immediate | 5 minutes | 15 minutes | 1 hour | 3 hours |
| 0 | 3 | 6 | 10 | 15 | 34 |
| 2.5 | 3 | 7 | 13 | 22 | 62 |
| 10 | 4 | 10 | 18 | 53 | >100 |
| 20 | 3 | 15 | 20 | 50 | >100 |

These results demonstrate that the difunctional cyclic carbonate of Example 4 increases the MEK resistance of cured films during the post cure period relative to formulations containing no cyclic carbonate groups.

### EXAMPLE 34

Varnish formulations were prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| Carbonate Examples 19, 20 & 21 | 10% |
| UVR6105 cycloaliphatic epoxide ex DOW | 87.9% |

A similar formulation was prepared but with no carbonate and an additional 10% epoxide. All formulations were printed onto Lenetta charts using a No. 1 K bar and cured at 100 m/minute under a 300 W/inch medium pressure mercury arc lamp operating at half power. Cure was assessed using the well known MEK solvent rub method immediately after cure, 5 minutes, 15 minutes, 1 hour and 24 hours after cure. All samples cured tack free immediately except for the one containing Example 20, which remained tacky to touch for a few minutes after cure. The results are shown in Table 5.

TABLE 5
MEK double rubs

| Example | Immediate | 5 minutes | 15 minutes | 1 hour | 24 hours |
|---|---|---|---|---|---|
| No carbonate | 3 | 6 | 10 | 26 | 120 |
| 10% | 3 | 7 | 10 | 15 | 95 |
| Example 21 | | | | | |
| 10% | 4 | 9 | 14 | 26 | 236 |
| Example 19 | | | | | |
| 10% | 2 | 3 | 10 | 34 | >300 |
| Example 20 | | | | | |

These results demonstrate that multifunctional 6-membered cyclic carbonate compounds such as Examples 19 and 20 increase the MEK resistance of cured films during the post cure period relative to formulations containing no or only monofunctional cyclic carbonate groups.

### EXAMPLE 35

Varnish formulations were prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| carbonate Example 6 | 0-28% |
| UVR6105 cycloaliphatic epoxide ex DOW | Remainder |

All formulations were printed onto Lenetta charts using a No. 1 K bar and cured at 100 m/minute under a 300 W/inch medium pressure mercury arc lamp operating at half power. Cure was assessed using the well known MEK solvent rub method immediately after cure, 15 minutes, 1 hour, 3 hours, 48 hours and 100 hours after cure. All samples cured tack free immediately. The results are shown in Table 6.

TABLE 6
MEK double rubs

| percent | | | | | 48 | 100 |
|---|---|---|---|---|---|---|
| carbonate | Immediate | 15 minutes | 1 hour | 3 hours | hours | hours |
| 0 | 3 | 5 | 6 | 6 | 30 | 45 |
| 5 | 3 | 8 | 12 | 16 | 48 | >50 |
| 10 | 3 | 8 | 17 | 27 | >50 | >50 |
| 15 | 3 | 10 | 19 | 29 | >50 | >50 |
| 20 | 3 | 11 | 24 | 36 | >50 | >50 |
| 25 | 3 | 11 | 22 | 32 | >50 | >50 |
| 28 | 2 | 12 | 18 | 24 | 32 | 48 |

These results demonstrate that the tetrafunctional cyclic carbonate, Example 6, increases the MEK resistance of cured films during the post cure period relative to formulations containing no cyclic carbonate groups.

### EXAMPLE 36

A varnish formulation was prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| carbonate Example 17 | 10% |
| UVR6105 cycloaliphatic epoxide ex DOW | 87.9% |

A similar formulation was prepared but with no carbonate and an additional 10% epoxide. Both formulations were printed onto Lenetta charts using a No. 1 K bar and cured at 100 m/minute under a 300 W/inch medium pressure mercury arc lamp operating at half power. Cure was assessed using the well known MEK solvent rub method immediately after cure, 15 minutes, 30 minutes, 1 hour, 2 hours and 18 hours after cure. Both formulations cured tack free immediately. The results are shown in Table 7.

TABLE 7

| | MEK double rubs | |
|---|---|---|
| Time after | 0% | |
| cure | carbonate | 10% Example 17 |
| Immediate | 6 | 6 |
| 15 minutes | 9 | 13 |
| 30 minutes | 10 | 15 |
| 1 hour | 14 | 18 |
| 2 hours | 21 | 26 |
| 18 hours | 31 | >50 |

These results demonstrate that the difunctional cyclic carbonate Example 17 increases the MEK resistance of cured films during the post cure period relative to formulations containing no cyclic carbonate groups.

### EXAMPLE 37

Varnish formulations were prepared based on

| | |
|---|---|
| S-biphenyl isopropyl thioxanthonium | 2.0% |
| hexafluorophosphate (Omnicat 550 ex IGM) | |
| Tegorad 2100 wetting aid ex TEGO | 0.1% |
| carbonate Examples 16 or 18 | 10% |
| UVR6105 cycloaliphatic epoxide ex DOW | 87.9% |

Both formulations were printed onto Lenetta charts using a No. 1 K bar and cured at 100 m/minute under a 300 W/inch medium pressure mercury arc lamp operating at half power. Both samples cured to give a tack free film immediately on cure. This demonstrates that the multifunctional cyclic carbonate Examples 16 and 18 can be incorporated into formulations without affecting their cure speed.

### EXAMPLE 38

Varnish formulations were prepared based on

| | |
|---|---|
| S-biphenyl thianthrenium | 2.0% |
| hexafluorophosphate | |
| Tegorad 2100 wetting aid ex TEGO | 0.1% |
| carbonate Examples 15, 23, 24, or 25 | 20% |
| UVR6105 cycloaliphatic epoxide ex DOW | 77.9% |

A similar formulation was prepared but with no carbonate and an additional 20% epoxide. All formulations were printed onto Lenetta charts using a No. 1 K bar and cured under a 300 W/inch medium pressure mercury arc lamp operating at half power. The maximum line speed for tack free cure was evaluated at carbonate content of 20% for carbonate Examples 15, 23, 24, and 25. The results are shown in Table 8.

TABLE 8

| Carbonate | |
|---|---|
| Example | Max tack free cure speed m/min |
| None | 55 |
| 15 | 95 |
| 23 | 100 |
| 24 | 35 |
| 25 | >80* |

*turns bright orange on UV irradiation, fading with time

These results demonstrate that cyclic carbonate compounds derived from rigid polymer epoxides can provide substantial improvements in tack fiee cure speed. Example 24 has a low carbonate functionality per gram and extremely soft flexible propylene oxide units in the molecule causing a reduction in tack-free cure speed but the attainment of an extremely flexible coating.

### EXAMPLE 39

Varnish formulations were prepared based on

| | |
|---|---|
| S-biphenyl thianthrenium hexafluorophosphate | 2% |
| Tegorad 2100 wetting aid ex TEGO | 0.1% |
| Carbonates shown in Table 9 | 10% |
| UVR6105 cycloaliphatic epoxide ex DOW | 87.9% |

A similar formulation was prepared but with no carbonate and an additional 10% epoxide. All formulations were printed onto Lenetta charts using a No. 1 K bar and cured under a 300 W/inch medium pressure mercury arc lamp at 50 m/minute and then left to post-cure for 1 hour. The isopropanol (IPA) solvent resistance of the cured films was assessed using the SATRA S™ 421 rub tester and the results are shown in Table 9.

TABLE 9

IPA double rubs

| Example | Immediate | 1 hour | 5 hours | 72 hours |
|---|---|---|---|---|
| No carbonate | 9 | 15 | 23 | 29 |
| Example 23 | 12 | 23 | 59 | 120 |
| Example 27 | 8 | 12 | 23 | 48 |
| Example 20 | 8 | 11 | 21 | 19 |
| Example 26 | 13 | 27 | 61 | 141 |
| Example 15 | 10 | 21 | 38 | 69 |

These results demonstrate that rigid polymer compounds with cyclic carbonate groups increase the IPA resistance of cured films, The exception is Example 20 which has a low carbonate functionality per gram as it is derived from a difunctional bisphenol A epoxy with an epoxy equivalent weight of 900.

### EXAMPLE 40

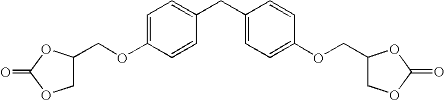

74.65 g of D.E.R. 354 liquid epoxy resin (Dow Chemical Company) and 0.74 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 75 g of a glassy solid.

The product was analysed by IR.

IR: very strong carbonate peak at 1794 cm⁻¹.

### EXAMPLE 41

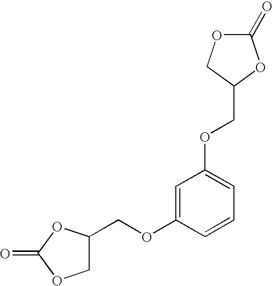

50.64 g of resorcinol diglycidyl ether and 0.50 g of tetrabutyl ammonium bromide were mixed in a 0.5 litre Parr pressure reactor with a magnetic stirrer The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 65 g of a glassy solid.

The product was analysed by IR.

IR: very strong carbonate peak at 1793 cm⁻¹.

### EXAMPLE 42

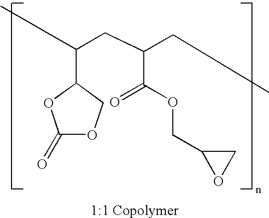

50.0 g of vinyl ethylene carbonate and 150 g of o-xylene were mixed in a 500 ml round bottomed flask equipped with a stirrer, condenser and nitrogen inlet/outlet. The mixture was heated to 100° C. under a nitrogen atmosphere. 50.0 g of glycidyl methacrylate and 2.0 g of 1,1′-azobis(cyclohexane carbonitrile) were added over a period of 140 minutes. The temperature was then maintained at 100° C. for a further 85 minutes. A further 0.2 g of 1,1′-azobis(cyclohexane carbonitrile) in 20 g of o-xylene was added and the mixture stirred for a further 2 hours at 100° C. The mixture was then cooled to room temperature. The solvent was removed by rotary evaporator to yield the product.

Product yield 99 g of a viscous liquid.

The product was analysed by IR and GPC.

IR: very strong ester peak at 1728 cm⁻¹, very strong carbonate peak at 1805 cm⁻¹.

### GPC: Mn 4636, Mw 12485, D 2.7.

### EXAMPLE 43

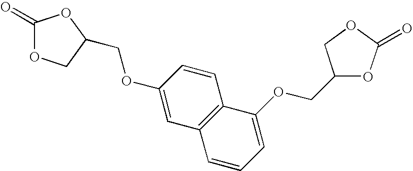

50.74 g of EPICLON HP-4032D from Dainippon Ink and Chemical Company, Japan, and 0.50 g of tetrabutyl ammonium bromide were mixed in a 0.5 litre Parr pressure reactor with a magnetic stirrer. The reactor was sealed and carbon dioxide gas was pressurised into the reactor to an initial pressure of approximately 350 psi at room temperature. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield 58 g of a glassy solid.

The product was analysed by IR.

IR: very strong carbonate peak at 1790 cm⁻¹.

### EXAMPLE 44

A white flexo ink was prepared based on;

| | |
|---|---|
| Titanium dioxide (FINNITITAN RDI/S ex Kemira) | 40.0% |
| UVR6105 cycloaliphatic epoxide ex DOW | 30.3% |
| OXT-221 (dioxetane monomer ex Toagosei)I | 10% |
| Carbonate examples | 10% |
| Omnicat 650 (photoinitiator ex IGM) | 5% |
| Solsperse 32000 pigment dispersant solution | 2.5% |
| Ebecryl 1360 (Silicone ex Cytec) | 2.0% |
| Tego Airex 920 (antifoam ex Goldschmidt) | 0.2% |

A similar formulation was prepared but with no carbonate and an additional 10% cycloaliphatic epoxide. All formulations were printed onto Lenetta charts using a No. 0 K bar and cured under a 300 W/inch medium pressure mercury arc lamp operating at full power. The maximum line speed for tack free cure was evaluated using the thumb twist test at a carbonate content of 10% for carbonate Examples 1, 4 & 8. The results are shown in Table 10.

TABLE 10

| Carbonate | |
|---|---|
| Example | Max tack free cure speed m/min |
| None | 60 |
| 1 | 60-65 |
| 4 | 75-80 |
| 8 | 65-70 |

The results demonstrate that multifunctional cyclic carbonates can be used to increase the cure speed of flexo ink formulations.

### EXAMPLE 45

Varnish formulations were prepared based on

| | |
|---|---|
| Omnicat 650 photoinitiator ex IGM | 2.0% |
| Tegorad 2100 wetting aid ex TEGO | 0.1% |
| Carbonate Example 4, 40 or 41 | 10% |
| UVR6105 cycloaliphatic epoxide ex DOW | 87.9% |

A similar formulation was prepared but with no carbonate and an additional 10% cycloaliphatic epoxide. All formulations were printed onto Lenetta charts using a No. 0 K bar and cured at 60 m/minute under a 300 W/inch medium pressure mercury arc lamp operating at half power. Prints were tested for isopropanol (IPA) resistance at various time intervals following cure using a Satra STM 421 rub tester with the foam pad soaked in IPA. The results are shown in Table 11.

TABLE 11
IPA solvent rubs

| Carbonate | | 15 | 2 | 18 | | |
|---|---|---|---|---|---|---|
| example | Immediate | minutes | hours | hours | 45 hours | 72 hours |
| No carbonate | 23 | 30 | 32 | 29 | 28 | 29 |
| 4 | 24 | 34 | 53 | 98 | 116 | 199 |
| 40 | 29 | 41 | 66 | 140 | 183 | >400 |
| 41 | 26 | 38 | 44 | 71 | 101 | 320 |

These results demonstrate that multifunctional cyclic carbonates can be used to significantly improve the solvent resistance of a cationic curing coating relative to formulations containing no cyclic carbonate groups.

### EXAMPLE 46

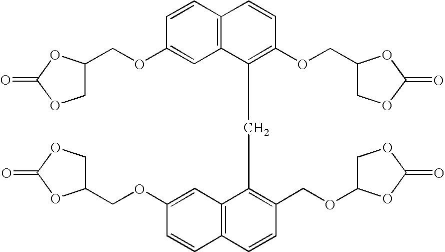

20 g of EPICLON HP-4700 from Dainippon Ink and Chemical Company, Japan and 0.20 g of tetrabutyl ammonium bromide were heated to 100° C. in a 0.5 litre Parr pressure reactor with a magnetic stirrer. The reactor was sealed and carbon dioxide gas was pressurised into the reactor to approximately 350 psi. The reactor was then heated to a temperature of approximately 150° C. The temperature/pressure profile was monitored throughout. When the temperature had been held constant at 150° C. and there appeared to be no further change in the pressure, the reactor was cooled and the pressure released. The product was removed from the reactor.

Product yield˜15 g of a very hard glassy solid.

The product was analysed by IR.

IR: very strong carbonate peak at 1790 cm⁻¹.

### EXAMPLE 47

Varnish formulations were prepared based on

| | |
|---|---|
| Omnicat 650 photoinitiator ex IGM | 2.0% |
| Tegorad 2100 wetting aid ex TEGO | 0.1% |
| Carbonate Example 43 | 10% |
| UVR6105 cycloaliphatic epoxide ex DOW | 87.9% |

A similar formulation was prepared but with no carbonate and an additional 10% cycloaliphatic epoxide. All formulations were printed onto Lenetta charts using a No. 0 K bar and cured at 60 m/minute under a 300 W/inch medium pressure mercury arc lamp operating at half power. Prints were tested for isopropanol (IPA) resistance at various time intervals following cure using a Satra STM 421 rub tester with the foam pad soaked in IPA. The results are shown in Table 12.

TABLE 12
IPA solvent rubs

| Carbonate | | 30 | 2 | 5 | | |
|---|---|---|---|---|---|---|
| example | Immediate | minutes | hours | hours | 21 hours | 48 hours |
| No carbonate | 20 | 26 | 19 | 25 | 36 | 44 |
| 43 | 25 | 41 | 48 | 66 | 121 | 118 |

These results demonstrate that multifunctional cyclic carbonates such as Example 43 can be used to significantly improve the solvent resistance of a cationic curing coating relative to formulations containing no cyclic carbonate groups.

### EXAMPLE 48

A varnish formulation was prepared based on

| | |
|---|---|
| Omnicat BL-550 photoinitiator solution ex IGM | 10.0% |
| Tegorad 2100 wetting aid ex TEGO | 0.2% |
| Carbonate Example 40 | 40% |
| UVR6105 cycloaliphatic epoxide ex DOW | 49.8% |

This formulation was found to have a viscosity of 122 Poise at 25° C. using an ICI cone and plate viscometer and is therefore capable of being printed by an offset or dry offset process. The formulation was printed onto a Lenetta charts using an IGT CI proofer and cured at 100 m/minute under a 300 W/inch medium pressure mercury arc lamp operating at half power. The varnish was found to be tack free and well cured as defined by the “thumb twist test” in only 1 pass; faster than most commercial varnishes and demonstrates the reactivity of the multifunctional carbonate Example 40.

A similar formulation where the carbonate Example 40 was replaced by the highly viscous novolac oxetane monomer PN0X (ex Toagosei) was found to have a viscosity of 57 Poise at 25° C. and cured at a similarly fast rate.

### EXAMPLE 49

A black ink formulation was prepared based on

| | |
|---|---|
| Omnicat BL-550 photoinitiator solution ex IGM | 20.0% |
| Special black 250 pigment | 15.0% |
| OXT 221 dioxetane monomer | 10.0% |
| Solsperse 32000 pigment dispersant | 1.25% |
| Carbonate Example 40 | 30% |
| UVR6105 cycloaliphatic epoxide ex DOW | 23.75% |

This formulation was found to have a viscosity of 67 Poise at 25° C. using an ICI cone and plate viscometer and is therefore capable of being printed by an offset or dry offset process. The formulation was printed at a density of 2.0 onto “polyboard” substrate using an IGT CT proofer and cured at 100 m/minute under a 300 W/inch medium pressure mercury arc lamp operating at full power. The ink was found to be tack free and well cured as defined by the “thumb twist test” in only 1 pass; faster than most commercial free radical curing inks and demonstrates the reactivity of the multifunctional carbonate Example 40.

1. An energy-curable composition comprising a polyfunctional cyclic carbonate, a monomer or oligomer copolymerisable with said polyfunctional cyclic carbonate and a cationic photoinitiator.

2. A composition according to claim 1, in which said polyfunctional cyclic carbonate is a compound of formula (I): 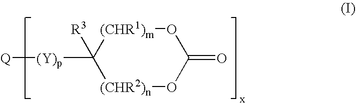
in which:
Q represents a polyvalent organic residue having a valency x>1 or a direct bond;
Y is an aliphatic carbon chain which may be interrupted by one or more oxygen atoms, sulphur atoms, phenylene groups, carbonyl groups, epoxide groups or linear or cyclic carbonate groups;
p is 0 or 1;
R¹ and R² are the same as or different from each other, and each represents a hydrogen atom, an alkyl group, a hydroxyalkyl group, an alkoxyalkyl group, an alkoxycarbonylalkyl group or a C₂-C₅ carbon chain which is attached to a carbon atom of Y to form a fused ring;
R³ represents a hydrogen atom or an alkyl group; and
m and n are the same as or different from each other, and each is a number from 0 to 4, provided that (m+n) is zero or a number from 1 to 4.

3. A composition according to claim 2, in which said polyfunctional cyclic carbonate is a compound of formula: 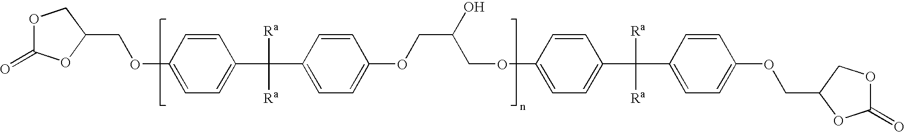
in which R^{a} represents a hydrogen atom or a methyl group and n is a degree of polymerisation.

4. A composition according to claim 2, in which said polyfunctional cyclic carbonate is a compound of formula: 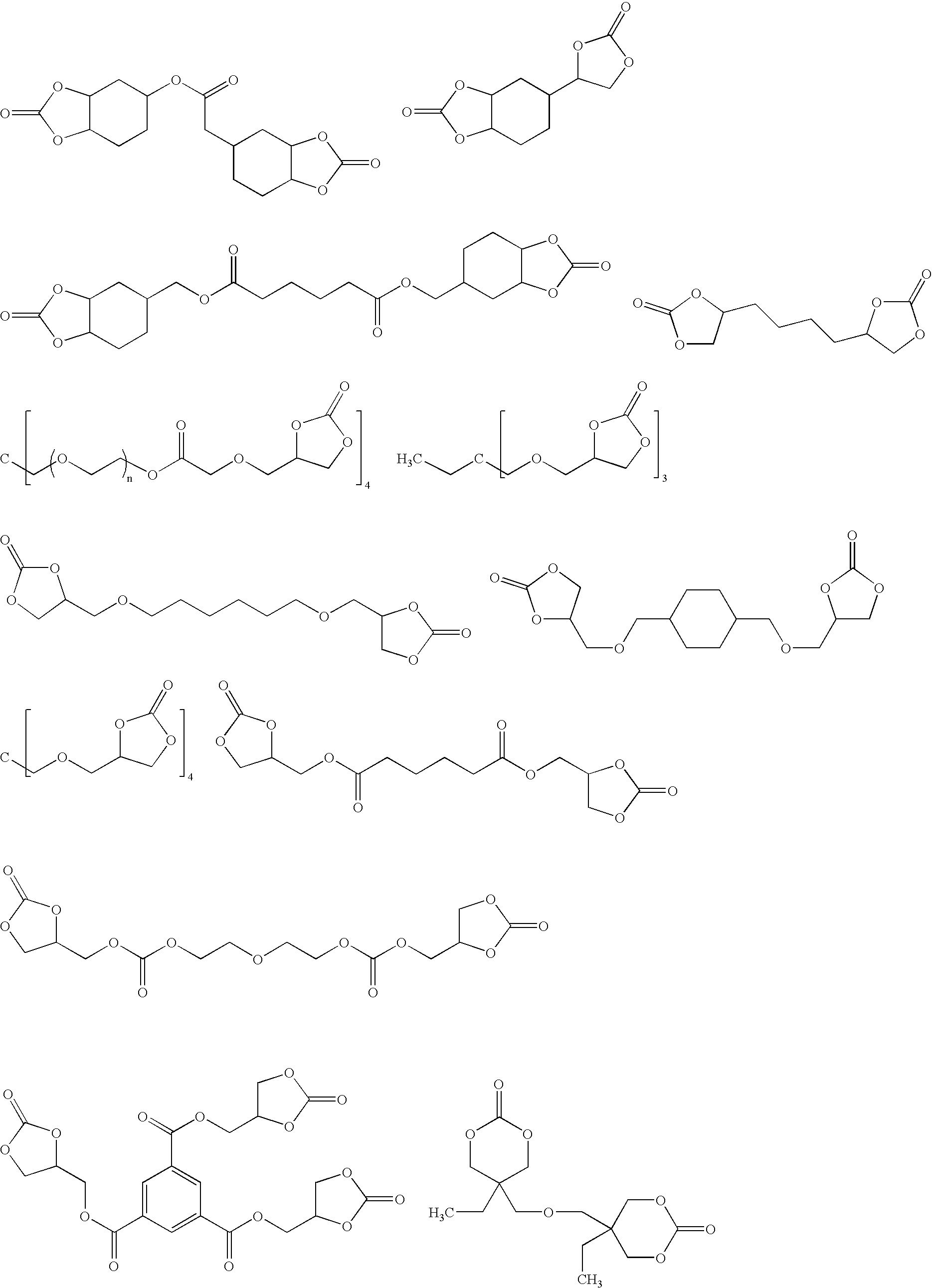 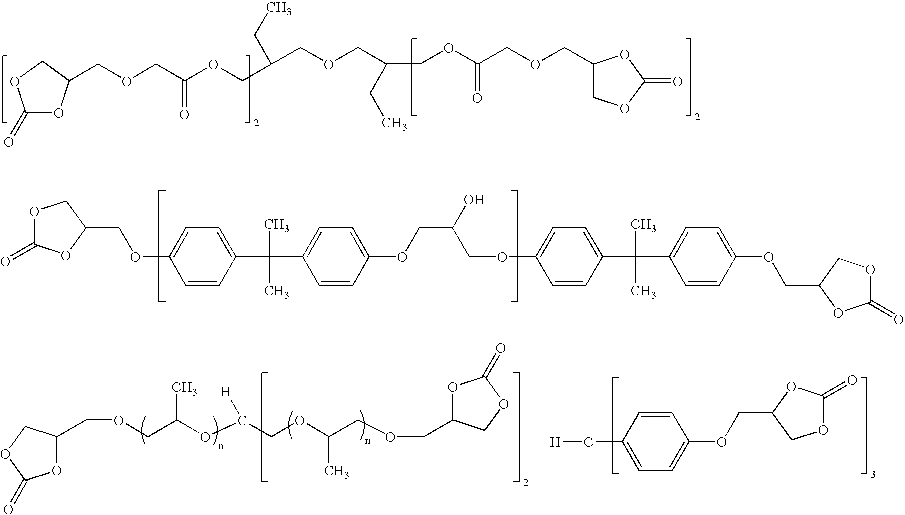
where n is a number denoting a degree of polymerisation.

5. A composition according to claim 2, in which said polyfunctional cyclic carbonate is epoxidised soya bean oil carbonate or epoxidised linseed oil carbonate.

6. A composition according to claim 1, in which said polyfunctional cyclic carbonate is a compound of formula (II): 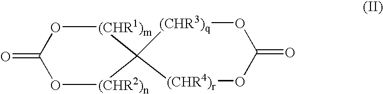
in which:
R¹, R², R³ and R⁴ are the same as or different from each other, and each represents a hydrogen atom, an alkyl group, a hydroxyalkyl group, an alkoxyalkyl group, or an alkoxycarbonylalkyl group;
m and n are the same as or different from each other, and each is zero or a number from 1 to 4, provided that (m+n) is zero or a number from 1 to 4; and
q and r are the same as or different from each other, and each is a number from 0 to 4, provided that (q+r) is a number from 1 to 4.

7. A composition according to claim 6, in which said polyfunctional cyclic carbonate is a compound of formula:

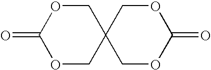

8. A composition according to claim 1, in which said polyfunctional cyclic carbonate is a polymeric compound having pendant carbonate groups.

9. A composition according to claim 8, in which said polyfunctional cyclic carbonate is a compound of formula: 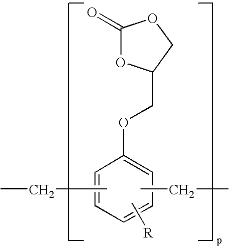
in which p is a number denoting a degree of polymerisation and R represents a hydrogen atom or an alkyl group.

10. A composition according to claim 1, in which said polyfunctional cyclic carbonate is a polymeric compound having carbonate groups in the main polymer chain.

11. A composition according to claim 10, in which said polyfunctional cyclic carbonate is a polyvinylidene carbonate.

12. A composition according to claim 1, in which said copolymerisable monomer or oligomer is an epoxide, an oxetane, or a sulphur analogue thereof.

13. A composition according to claim 12, in which said copolymerisable monomer or oligomer is an epoxide or an oxetane.

14. A composition according to claim 13, in which said copolymerisable monomer or oligomer is an epoxide and an oxetane.

15. A composition according to claim 13, in which said copolymerisable monomer or oligomer is a cycloaliphatic epoxide.

16. A composition according to claim 1, in which the polyfunctional cyclic carbonate comprises from 1 to 50% by weight of the total polymerisable components of the composition.

17. A composition according to claim 16, in which the polyfunctional cyclic carbonate comprises from 10 to 30% by weight of the total polymerisable components of the composition.

18. A composition according to claim 17, in which the polyfunctional cyclic carbonate comprises from 15 to 25% by weight of the total polymerisable components of the composition.

19. A composition according to claim 1, formulated as a printing ink, varnish or adhesive.

20. A composition according to claim 19, additionally comprising a colorant.

21. A composition according to claim 19, formulated as an inkjet ink.

22. A composition according to claim 19, formulated as a flexographic ink.

23. A composition according to claim 19, formulated for gravure printing.

24. A composition according to claim 19, formulated for lithographic printing.

25. A composition according to claim 24 which is a varnish.

26. A composition according to claim 24 which is a printing ink.

27. A method of producing a cured coating, which comprises applying a composition according to claim 1 to a substrate and exposing the composition to curing energy.

28. A method according to claim 27, in which said curing energy is ultraviolet.
